(19) United States
(12) Patent Application Publication
(10) Pub. No.: US 2018/0038052 A1
(43) Pub. Date: Feb. 8, 2018

(54) RAIL CLIP TOOL

(71) Applicant: PROGRESS RAIL SERVICES CORPORATION, Albertville, AL (US)

(72) Inventor: Thai Nguyen, De Soto, KS (US)

(21) Appl. No.: 15/546,927

(22) PCT Filed: Feb. 9, 2016
(86) PCT No.: PCT/US2016/017068

§ 371 Date: Jul. 27, 2017

(30) Foreign Application Priority Data
Feb. 16, 2015 (AU) 2015900494

(51) Int. Cl. E01B 29/24; B25B 27/14

(52) U.S. Cl. CPC E01B 29/24; B25B 27/146; E01B 9/60

(57) ABSTRACT

A tool for removing rail clips of the kind which are applied transversely to the rail, which includes a pair of levers connected at a pivot point and being adapted to move toward or away from each other. Each lever has at its lower end, a rail clip engagement face which engage opposed sides of a rail clip seating transversely on the rail base. Each clip engagement face includes a clamp plate adapted to abut one side of the toes of the rail clip, an engagement pin adapted to engage one side of the rear portion of said rail clip, and a reaction pivot rear edge adapted to pivot about a point behind said rail clip. This arrangement allows the tool to be opened by moving the levers away from each other, placing the engagement faces on either side of the clip and then bringing the levers together so that the clamp plates compress the toes of the clip together so that the clip can be removed rearwardly from the rail clip support shoulder. When the toes are compressed the engagement pin abuts the rear curved portion of the rail clip and by pulling the levers away from the rail about the rear pivot base edge the rail clip is withdrawn from the base of the rail into the rail clip support shoulder.

This invention relates to a tool for use in removing rail clips of the kind which are applied transversely to the rail.

### BACKGROUND TO THE INVENTION

A popular version of rail fasteners applied transversely to a rail is disclosed in U.S. Pat. No. 4,313,563. These clips normally lose some clamping force after machine installation. A recent improved version is disclosed in U.S. application Ser. No. 14/396,351 (WO2013/160760). This improvement is designed to withstand machine overloading during installation and provide adequate clamping force after multiple installation and removal. This clip has a specially designed rear arch geometry and cannot be removed with a standard removal tool.

U.S. Pat. Nos. 5,392,504 and 5,884,381 disclose a tool for removing a rod version of the transversely applied rail fasteners.

U.S. Pat. Nos. 5,839,377 and 6,138,573 disclose a machine for applying and removing standard transverse clips.

It is an object of this invention to provide a clip removal tool that with the capability of removing standard clips and the improved clip.

### BRIEF DESCRIPTION OF THE INVENTION

To this end the present invention provides a tool for removing rail clips of the kind which are applied transversely to the rail which includes a pair of levers connected at a pivot point and being adapted to move toward or away from each other,

each lever having at its lower end a rail clip engagement face which engage opposed sides of a rail clip seating transversely on the rail base

each clip engagement face including a clamp plate adapted to abut one side of the toes of the rail clip, an engagement pin adapted to engage one side of the rear portion of said rail clip, and a reaction pivot rear edge adapted to pivot about a point behind said rail clip.

This arrangement allows the tool to be opened by moving the levers away from each other, placing the engagement faces on either side of the clip and then bringing the levers together so that the clamp plates compress the toes of the clip together so that the clip can be removed rearwardly from the rail clip support shoulder. When the toes are compressed the engagement pin abuts the rear curved portion of the rail clip and by pulling the levers away from the rail about the rear pivot base edge the rail clip is withdrawn from the base of the rail into the rail clip support shoulder. Each lever is attached to an end of the clip engagement face remote from said reaction pivot rear edge.

The preferred tool has a unique removal parallelogram shape pin which contacts the clip at a middle position in the clip rear arch area, and a round pivot geometry which contacts the rail support shoulder or the rail tie at a position behind the rail clip. The preferred clip and pivot contact point combination provides approximately 60 pounds of removal force per each 1 pound of hand applied force. Therefore, the tool operator uses much less force than the standard removal tool. The tool also increases the worker safety because the tool operator is less likely to fall backward during the removal operation.

### DETAILED DESCRIPTION OF THE INVENTION

A preferred embodiment of the invention will now be described with reference to the drawings in which:

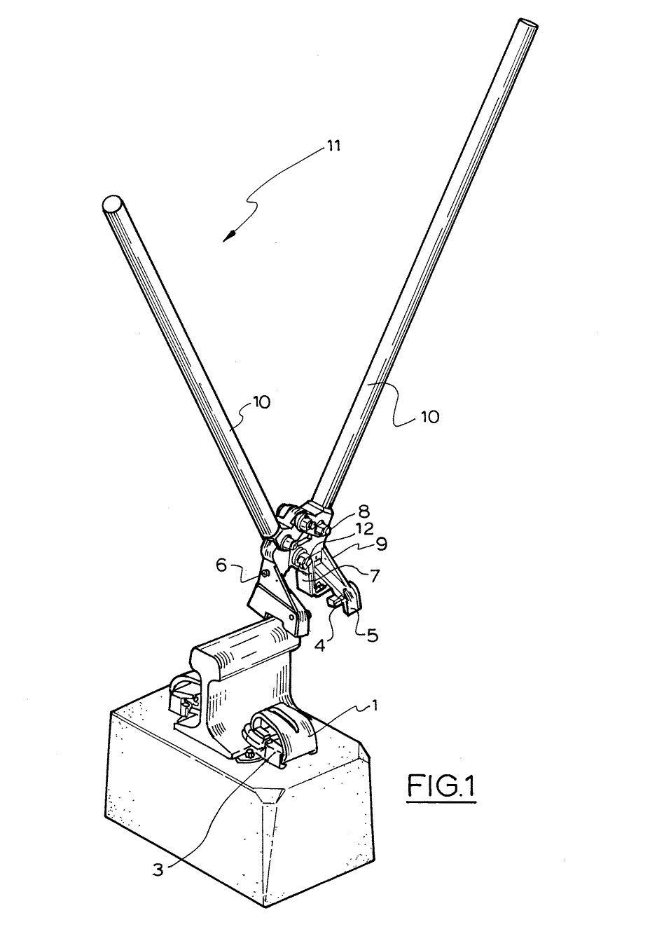

FIG. 1 illustrates the tool of this invention to be used with a rail clip as described in WO2013/160760;

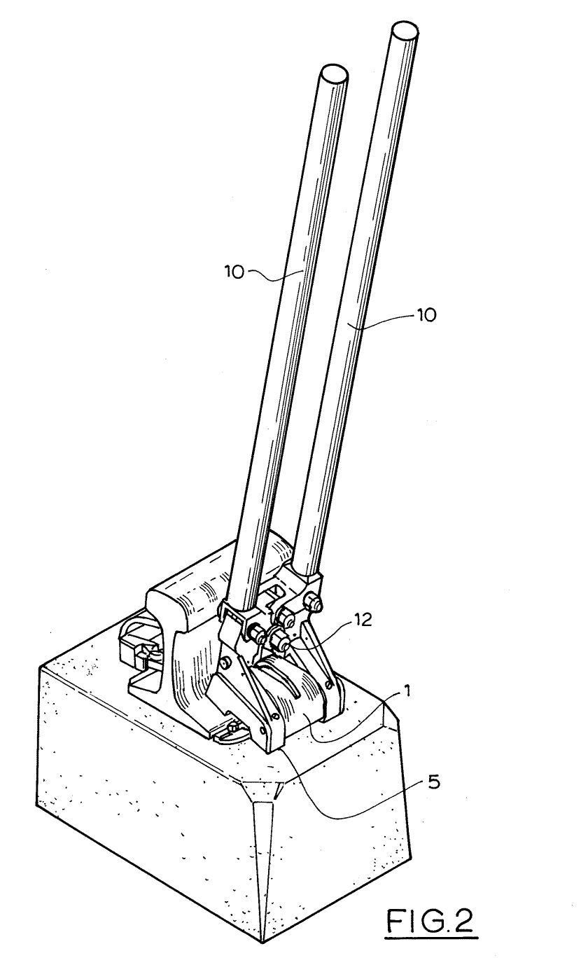

FIG. 2 illustrates the tool closed about the rail clip of FIG. 1;

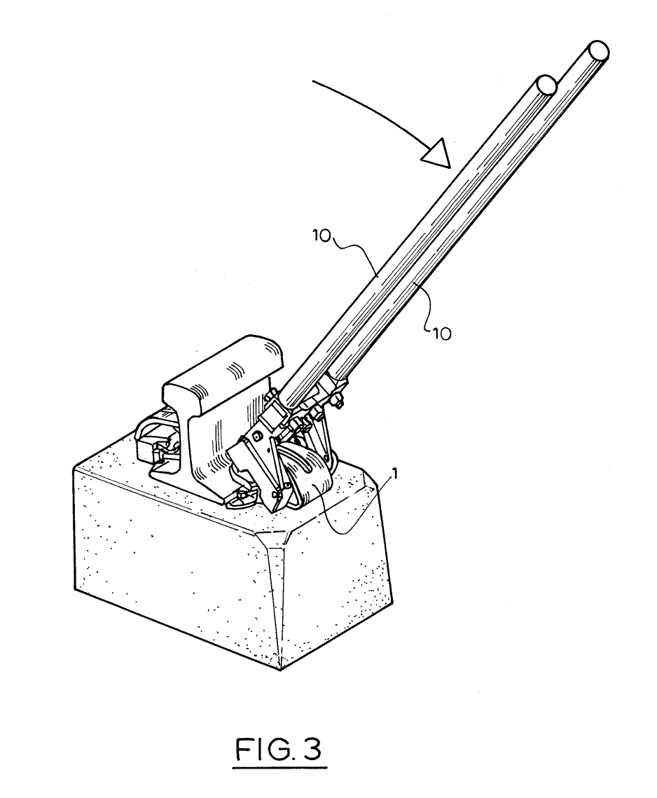

FIG. 3 illustrates the movement of the tool to remove the rail clip of FIG. 2;

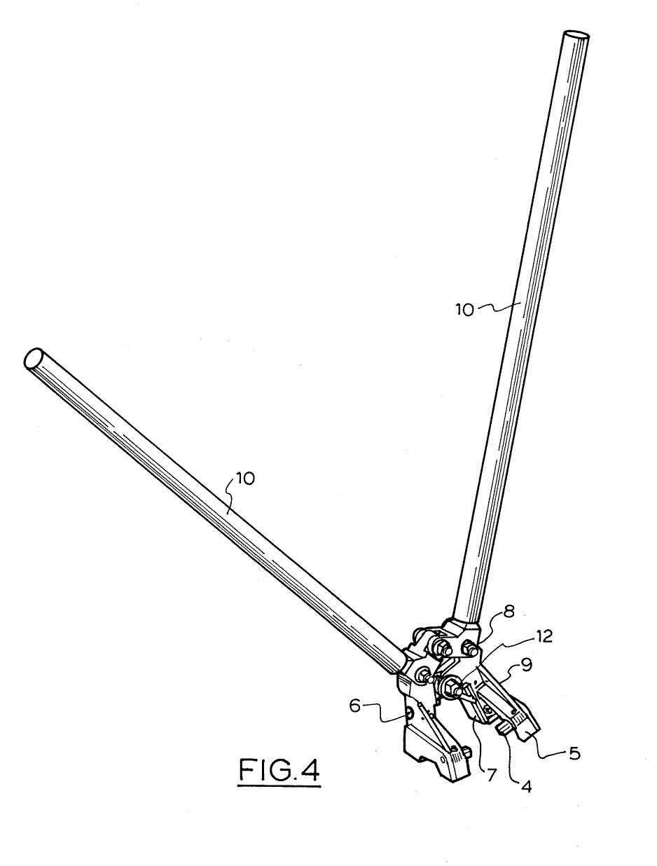

FIG. 4 illustrates the components of the tool of FIG. 1 in its open position;

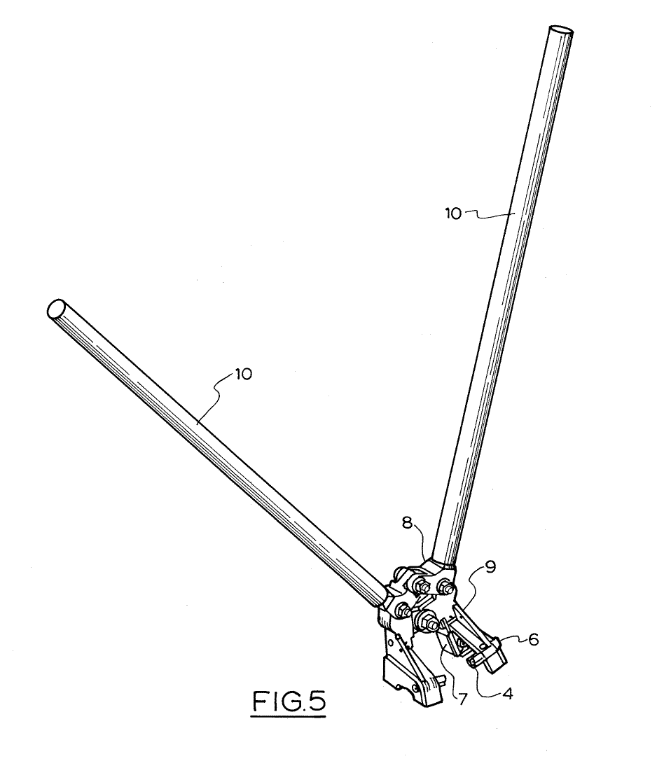

FIG. 5 illustrates the components of the tool of this invention configured for use with standard rail clips;

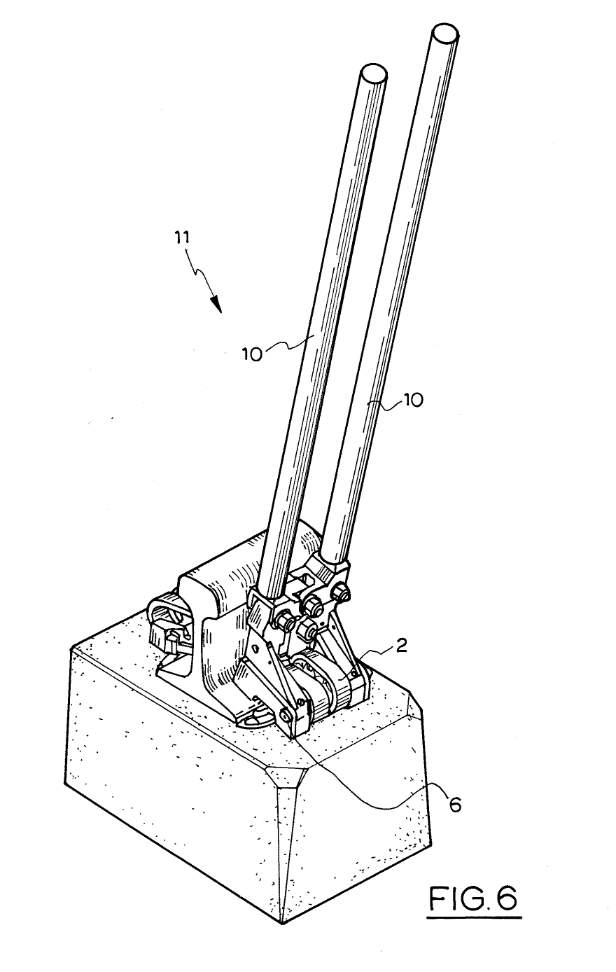

FIG. 6 illustrates the tool of this invention to be used with a rail clip as described in USA 4313563;

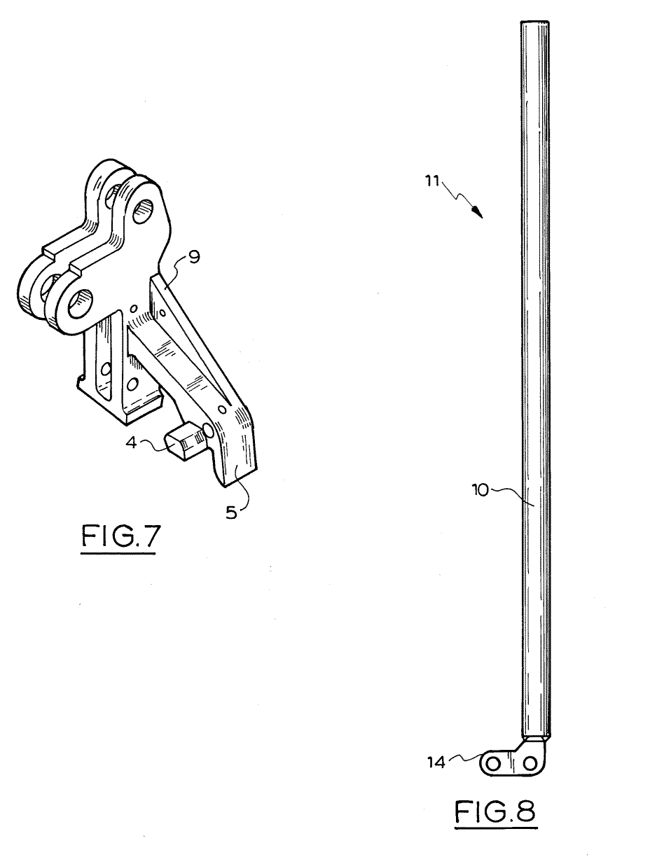

FIG. 7 illustrates the features of the base of the tool of this invention;

FIG. 8 depicts the tool handles.

In FIG. 1 the rail clip 1 as described in WO2013/160760 is installed on shoulder 3 and the tool 11 is opened by moving the lever arms 10 apart. In FIG. 2 the lever arms 10 are brought together so that the compression plate 7 squeezes the toes of the clip 1 so that the clip 1 can pass backwards out of shoulder 3. In FIG. 2 the round pivot geometry of pivot edge 5 engages the rail tie behind the clip 1.

In FIG. 3 the tool 11 is pulled away from the rail about the pivot line 5 so that clip 1 moves off the rail base into the rail shoulder 3. The engagement pin 4 engages the the clip 1 at a middle position in the clip rear arch area to pull the clip 1 backwards.

In the tool 11, the lever arms 10 as shown in FIG. 8, are connected by the bracket 14 at the end of the lever arms, to the base pivot arm 9 at a junction 8 and the two lever arms pivot about pin 12. The base is shown in FIG. 7. The clamp plate 7 is fixed to the pivot arm 9 at the end remote from the pivot edge 5. The clip engagement pin 4 is located appropriately above pivot edge 5 on the pivot base 9 as shown in FIG. 7.

In FIGS. 5 and 6 the tool is shown with a standard rail clip 2 as described in U.S. Pat. No. 4,313,563. To enable the rear curved portion of clip 2 to be engaged a pin 6 is inserted in a recess adjacent the pin 4. This pin is stowed in the position shown in FIG. 4 when the tool is used with clips of type 1.

Those skilled in the art will realise that the tool operator uses much less force than with a standard removal tool while increasing the worker safety because the tool operator is less likely to fall backward.

Those skilled in the art will also realise that this invention may be implemented in embodiments other than those disclosed without departing from the core teachings of this invention.

1. A tool for removing rail clips of the kind which are applied transversely to the rail, the tool comprising
a pair of levers connected at a pivot point and being adapted to move toward or away from each other, each lever having a lower end including a rail clip engagement face, the rail clip engagement faces configured to engage opposed sides of a rail clip seating transversely on the rail base, each clip engagement face including a clamp plate adapted to abut one side of toes of the rail clip, an engagement pin adapted to engage one side of a rear portion of said rail clip, and a reaction pivot rear edge on each clip engagement face adapted to pivot about a point behind said rail clip.

2. A tool as claimed in claim 1 in which the engagement pins are changed to suit different versions of the rail clip.

3. A tool as claimed in claim 1 wherein each lever is attached to an end of the clip engagement face remote from said reaction pivot rear edge.
